(19) United States
(12) Patent Application Publication
(10) Pub. No.: US 2019/0003361 A1
(43) Pub. Date: Jan. 3, 2019

(54) FUEL REFORMING SYSTEM

(71) Applicants: Hyundai Motor Company, Seoul (KR); Kia Motors Corporation, Seoul (KR)

(72) Inventors: Seung Woo Lee, Seoul (KR); Hong Kil Baek, Seoul (KR); Tae Won Lee, Incheon (KR)

(73) Assignees: Hyundai Motor Company, Seoul (KR); Kia Motors Corporation, Seoul (KR)

(21) Appl. No.: 15/811,401

(22) Filed: Nov. 13, 2017

(30) Foreign Application Priority Data
Jun. 30, 2017 (KR) 10-2017-0083649

(51) Int. Cl. F01N 3/20; F01N 13/00; F01N 3/08; B01D 53/94

(52) U.S. Cl. CPC F01N 3/208; F01N 3/206; B01D 53/9431; F01N 3/0814; F01N 13/017

(57) ABSTRACT

A fuel reforming system may include an engine combusting reformed gas to generate mechanical power, an intake line connected to the engine to supply reformed gas and air to the engine, an exhaust line connected to the engine to circulate exhaust gas expelled from the engine, a fuel reformer provided at an exhaust gas recirculation (EGR) line diverging from the exhaust line, into which a fuel is injected from the EGR line, mixing the fuel injected from the EGR line and the EGR gas, and reforming the fuel mixed in the EGR gas, and a catalyst disposed in the exhaust line and purifying nitrogen oxide included in the exhaust gas at a front end portion of the fuel reformer.

### CROSS-REFERENCE TO RELATED APPLICATION

The present application claims priority to Korean Patent Application No. 10-2017-0083649 filed on Jun. 30, 2017, the entire contents of which is incorporated herein for all purposes by this reference.

### BACKGROUND OF THE INVENTION

### Field of the Invention

The present invention relates to a fuel reforming system. More particularly, the present invention relates to a fuel reforming system including a reforming catalyst portion having a heat transfer structure in a fuel reformer.

### Description of Related Art

Generally, an exhaust gas recirculation (EGR) system is a system which is disposed at a vehicle for decreasing noxious exhaust gas.

This exhaust gas recirculation system reduces oxygen amount in a mixer by circulating a portion of the exhaust gas expelled from the engine, reduces exhaust amount of the exhaust gas, and reduces toxic matters in the exhaust gas.

Also, the exhaust gas expelled from the engine has high temperature, therefore the engine efficiency may be improved by utilizing the thermal energy of the exhaust gas.

Meanwhile, a fuel reformer is a device which changes fuel characteristics by use of catalyst, and the fuel reformer may be applied for increasing combustion efficiency or activating of post processing system.

For improving fuel reforming efficiency, it is important to attain sufficient activation temperature of a fuel catalyst. By the way, EGR gas has to be sufficiently heated to attain sufficient activation temperature for fuel reforming, however, it is difficult to attain activation temperature according to driving condition and supply amount of the EGR gas. There is a problem that reforming efficiency decreases because temperature of mixed gas decreases substantially during mixing of fuel and the EGR gas in a mixing portion of the fuel reformer.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a fuel reforming system including a reforming catalyst portion having a heat transfer structure of mixed gas and exhaust gas in a fuel reformer to attain sufficient activation temperature of reforming catalyst for reforming reaction.

A fuel reforming system according to an exemplary embodiment of the present invention may include an engine combusting reformed gas to generate mechanical power, an intake line connected to the engine to supply reformed gas and air to the engine, an exhaust line connected to the engine to circulate exhaust gas expelled from the engine, a fuel reformer provided at an exhaust gas recirculation (EGR) line diverging from the exhaust line, into which a fuel is injected from the EGR line, mixing the fuel injected from the EGR line and the EGR gas, and reforming the fuel mixed in the EGR gas, and a catalyst disposed at the exhaust line and purifying nitrogen oxide included in the exhaust gas at a front end portion of the fuel reformer. The fuel reformer may include a reforming catalyst portion reforming the mixed fuel and the EGR gas, and the reforming catalyst portion may include mats, a first carrier disposed between the mats and in which caves and hills are formed along a direction the exhaust gas flows, and a second carrier disposed at a portion opposite to the first carrier located between the mat and in which caves and hills are formed along a direction the mixed fuel and the EGR gas flows.

The fuel reformer may include a housing, a mixing portion provided in the housing and being a space mixing the fuel supplied from outside and the EGR gas, a fuel injector disposed at one side of the housing and supplying the fuel to the mixing portion, and an EGR pipe connected to the mixing portion in which the EGR gas flows.

The caves and hills of the first and second carriers may be alternatively disposed.

The caves and hills of the first carrier and the caves and hills of the second carrier may be disposed in a vertical direction with respect to each other.

The first carrier and the second carrier may include steel.

Platinum (Pd), rhodium (Rh) or palladium (Pd) may be coated on the first carrier and the second carrier.

The fuel reforming system according to an exemplary embodiment of the present invention may further include a compressor connected to the intake line and compresses the reformed gas and air to supply to the engine, and a turbine connected to the exhaust line and rotating by the exhaust gas to generate power.

The catalyst may include a lean NOx trap (LNT) which traps the nitrogen oxide included in the exhaust gas in a lean condition and desorbs the trapped nitrogen in a rich condition, and restores the nitrogen oxide included in the exhaust gas or the desorbed nitrogen oxide.

The catalyst may include a selective catalytic reducer (SCR) restoring the nitrogen oxide included in the exhaust gas by use of reducing agent.

At the EGR line, an EGR valve adjusting flow rate of the reformed gas, and an EGR cooler disposed at a rear end portion of the EGR valve and cooling the reformed gas may be disposed.

The reformer may be disposed at a front portion of the EGR cooler in the EGR line.

According to an exemplary embodiment of the present invention, a reforming catalyst portion having a heat transfer structure of mixed gas and exhaust gas in a fuel reformer is provided to attain sufficient activation temperature of reforming catalyst for reforming reaction, therefore maximizes generation of hydrogen and improves reforming efficiency.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view illustrating a fuel reforming system according to an exemplary embodiment of the present invention.

FIG. 2 is a schematic view illustrating a fuel reformer according to an exemplary embodiment of the present invention.

FIG. 3 is a schematic view illustrating a reforming catalyst portion of a fuel reformer according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Furthermore, in exemplary embodiments, since like reference numerals designate like elements having the same configuration, a first exemplary embodiment is representatively described, and in other exemplary embodiments, only configurations different from the first exemplary embodiment will be described.

The drawings are schematic, and are not illustrated in accordance with a scale. Relative dimensions and ratios of portions in the drawings are illustrated to be exaggerated or reduced in size for clarity and convenience, and the dimensions are just exemplified and are not limiting. Furthermore, same structures, elements, or components illustrated in two or more drawings use same reference numerals for showing similar features. It will be understood that when an element including a layer, film, region, or substrate is referred to as being “on” another element, it can be directly on the other element or intervening elements may also be present.

The exemplary embodiment of the present invention shows an exemplary embodiment of the present invention more specifically. As a result, various modifications of the drawings will be expected. Therefore, the exemplary embodiment is not limited to a specific aspect of the illustrated region, and for example, includes modifications of an aspect by manufacturing.

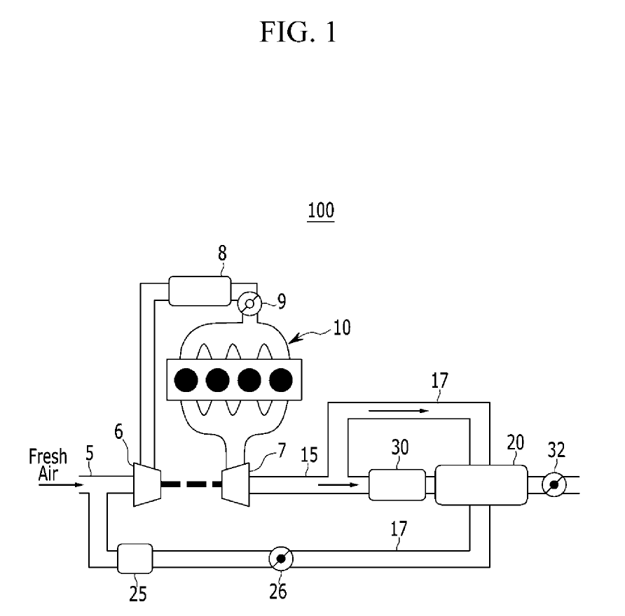

Now, a fuel reforming system according to an exemplary embodiment of the present invention will be described with reference to FIG. 1.

FIG. 1 is a schematic view illustrating a fuel reforming system according to an exemplary embodiment of the present invention.

Referring to FIG. 1, a reforming system includes an engine 10, an intake line 5, an exhaust line 15, a fuel reformer 20, and a catalyst 30.

The engine 10 burns air-fuel mixture in which fuel and air are mixed to convert chemical energy into mechanical energy. The engine 10 is connected to an intake manifold to receive the air in a combustion chamber, and is connected to an exhaust manifold such that exhaust gas generated in combustion process is gathered in the exhaust manifold and is expelled to the external. An injector is mounted in the combustion chamber to inject the fuel into the combustion chamber.

A diesel engine is exemplified herein, but a lean-burn gasoline engine may be used. In a case that the gasoline engine is used, the air-fuel mixture flows into the combustion chamber through the intake manifold, and a spark plug is mounted at an upper portion of the combustion chamber. In a case that the gasoline engine is used, the air-fuel mixture flows into the combustion chamber through the intake manifold, and a spark plug is mounted at an upper portion of the combustion chamber.

Furthermore, the engines having various compression ratios, preferably a compression ratio equal to or less than 16.5, may be used.

The intake line 5 is connected to entrance of the engine 10 to supply reformed gas and air to the engine 10, and the exhaust line 15 is connected to exit of the engine 10 to circulate exhaust gas expelled from the engine 10.

A portion of the exhaust gas expelled from the engine is supplied to the engine 10 through the EGR line 17. Also, the EGR line 17 is connected to the intake manifold so that combustion temperature is controlled by mixing a portion of the exhaust gas with air. This combust temperature control is conducted by adjusting exhaust gas amount supplied to the intake manifold. Accordingly, EGR valve 26 adjusting flow rate of the reformed gas may be disposed at the EGR line 17.

An exhaust gas recirculation system realized by the EGR line 17 supplies a portion of the exhaust gas to the intake system and inflows to combustion chamber when exhaust amount of the nitrogen oxide needs to be reduced according to driving condition. As such, the exhaust gas which is inert gas whose volume is not changed depresses density of the air-fuel mixture and flame transmitting speed is reduced during combustion of the fuel. Therefore, combustion velocity of the fuel is reduced and raise of the combustion temperature is reduced to depress generation of the nitrogen oxide.

A fuel reformer 20 is provided at an exhaust gas recirculation (EGR) line 17 diverging from the exhaust line 15, and a fuel is injected from the EGR line 17 into the reformer 20, and in which the fuel injected and the EGR gas from the EGR line 17 is mixed, and reforms the fuel mixed in the EGR gas.

The catalyst 30 is disposed at the exhaust line 15 and purifies nitrogen oxide included in the exhaust gas at a front end portion of the fuel reformer 20.

The catalyst 30 may include a lean NOx trap (LNT) which traps the nitrogen oxide included in the exhaust gas in a lean condition and desorbs the trapped nitrogen in a rich condition, and restores the nitrogen oxide included in the exhaust gas or the desorbed nitrogen oxide. The LNT may oxidize carbon monoxide (CO) and hydrocarbon (HC) included in the exhaust gas. Here, it should be understood that the hydrocarbon is used to imply compound including carbon and hydrogen in exhaust gas and fuel.

Also, the catalyst 30 may include a selective catalytic reducer (SCR) restoring the nitrogen oxide included in the exhaust gas by use of reducing agent. The reducing agent may be urea injected from an injection module.

The catalyst 30 may be integrally formed with the reforming catalyst portion 40 of the fuel reformer 20, or omitted.

Meanwhile, the fuel reforming system 100 according to an exemplary embodiment of the present invention may further include a compressor 6 connected to the intake line 5 and compresses the reformed gas and air to supply to the engine 10, and a turbine 7 connected to the exhaust line 15 and rotates by the exhaust gas to generate power.

Also, the reforming system 100 may include an intercooler 8 connected to the compressor 6 and cooling air and reformed gas flowed into the intake line 5 of the engine 10 again, and a throttle valve 9 adjusting flow rate of the air and reformed gas.

An exhaust pressure control valve 32 adjusting flow rate of the exhaust gas may be provided at a rear end portion of the catalyst 30 in the exhaust line 15.

Meanwhile, at the EGR line 17, an EGR valve 26 adjusting flow rate of the reformed gas and an EGR cooler 25 disposed at a rear end portion of the EGR valve 26 and cooling the reformed gas may be disposed.

At the present time, the fuel reformer 20 may be disposed at a front portion of the EGR cooler 27 in the EGR line 17.

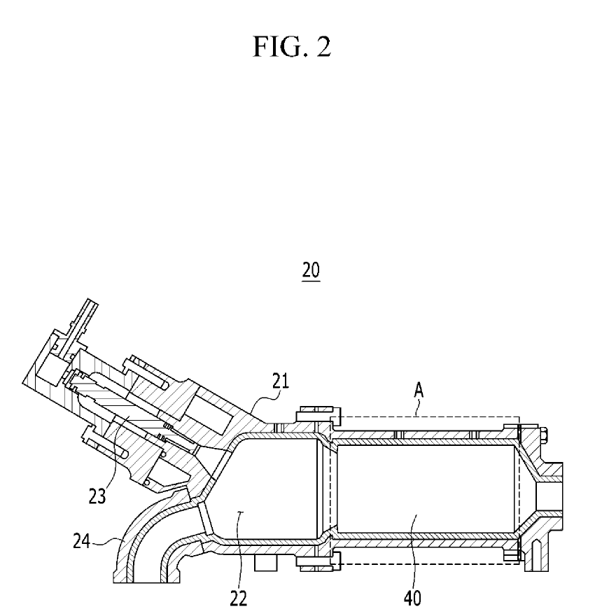

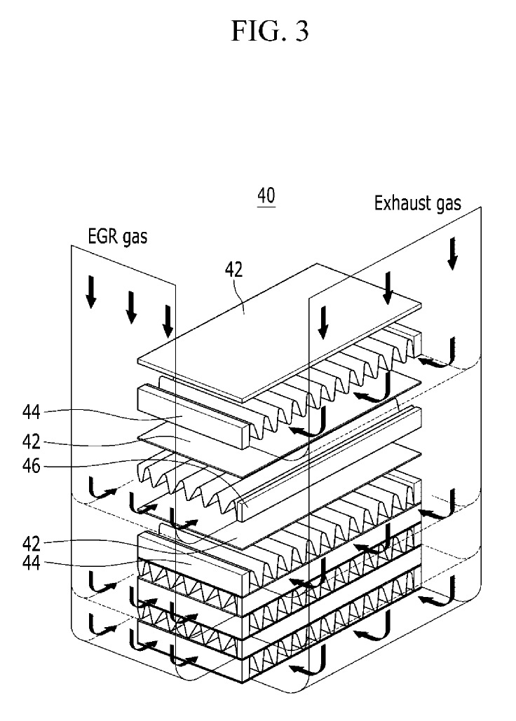

FIG. 2 is a schematic view illustrating a fuel reformer according to an exemplary embodiment of the present invention, and FIG. 3 is a schematic view illustrating a reforming catalyst portion of a fuel reformer according to an exemplary embodiment of the present invention.

Referring to FIG. 2, the fuel reformer 20 includes a housing 21, a mixing portion 22 provided in the housing 21 and being a space mixing the fuel supplied from outside and the EGR gas, a fuel injector 23 disposed at one side of the housing 21 and supplying the fuel to the mixing portion 22, an EGR pipe 24 connected to the mixing portion 22 in which the EGR gas flows, and reforming catalyst portion 40, A disposed at a rear end portion of the mixing portion 22 and reforming the mixed fuel and the EGR gas.

Referring to FIG. 3, the reforming catalyst portion 40, an includes a mat 42, a first carrier 44, and a second carrier 46.

The mat 42 supports and surrounds the first carrier 44 and the second carrier 46, and is accommodated in a shell made of metal. The first carrier 44 and the second carrier 46 may include steel, and noble metal may be coated on the first carrier 44 and the second carrier 46. A noble metal including platinum (Pd), rhodium (Rh) or palladium (Pd) may be used for coating the first carrier 44 and the second carrier 46.

The first carrier 44 is disposed between the mats 42, and in which caves and hills are formed along a direction the exhaust gas flows

Also, the second carrier 46 is disposed at a portion opposite to the first carrier 44 and located between the mats 42 and in which caves and hills are formed along a direction the mixed fuel and the EGR gas flows.

In FIG. 3, four first carrier 44 and three second carrier 46 are described here, but the spirit of the present invention is not limited to this. The numbers of the first carrier 44, the second carrier 46, and the mats 42 may be varied.

The caves and hills of the first carrier 44 may be alternatively disposed, and the caves and hills of the second carrier 46 may be also alternatively disposed. The caves and hills of the first and second carriers 44 and 46 may have various shapes, which are not limited to the shape illustrated in FIG. 3.

The caves and hills of the first carrier 44 and the caves and hills of the second carrier 46 may be disposed in a vertical direction with respect to each other. The exhaust gas flowing through the caves of the first carrier 44 and the mixed fuel and EGR gas flowing through the caves of the second carrier 46 flows into a crossing direction each other, and the exhaust gas and the mixed fuel and EGR gas exchange heat each other, and may additionally heats the reforming catalyst portion 40 by use of heat of the exhaust gas.

By the present heat transfer structure, the temperature of the fuel and the EGR gas may rise sufficiently by being transferred from exhaust heat of the exhaust gas at the reforming catalyst portion 40, therefore activation temperature of the reforming catalyst may be attained sufficiently.

Like this, various aspects of the present invention are directed to providing a fuel reforming system including a reforming catalyst portion having a heat transfer structure of mixed gas and exhaust gas in a fuel reformer to attain sufficient activation temperature of reforming catalyst for reforming reaction.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel reforming system, comprising:
an engine combusting reformed gas to generate mechanical power;
an intake line connected to the engine to supply the reformed gas and an air to the engine;
an exhaust line connected to the engine to circulate exhaust gas expelled from the engine;
a fuel reformer provided at an exhaust gas recirculation (EGR) line diverging from the exhaust line, into which a fuel is injected from the EGR line, mixing the fuel injected from the EGR line and EGR gas, and reforming the fuel mixed in the EGR gas; and
a catalyst disposed in the exhaust line and purifying nitrogen oxide included in the exhaust gas at a front end portion of the fuel reformer, the fuel reformer including a reforming catalyst portion reforming the mixed fuel and the EGR gas,
wherein the reforming catalyst portion includes mats, a first carrier disposed between the mats and in which caves and hills are formed along a direction the exhaust gas flows, and a second carrier disposed at a portion opposite to the first carrier located between the mats and in which caves and hills are formed along a direction the mixed fuel and the EGR gas flows.

2. The fuel reforming system of claim 1, wherein the fuel reformer includes:
a housing;
a mixing portion provided in the housing and being a space mixing the fuel supplied from outside and the EGR gas;
a fuel injector disposed at a first side of the housing and supplying the fuel to the mixing portion; and
an EGR pipe connected to the mixing portion in which the EGR gas flows.

3. The fuel reforming system of claim 1, wherein the caves and hills of the first and second carriers are alternatively disposed.

4. The fuel reforming system of claim 1, wherein the caves and hills of the first carrier and the caves and hills of the second carrier are disposed in a vertical direction thereof with respect to each other.

5. The fuel reforming system of claim 1, wherein the first carrier and the second carrier include steel.

6. The fuel reforming system of claim 1, wherein platinum (Pd), rhodium (Rh) or palladium (Pd) is coated on the first carrier and the second carrier.

7. The fuel reforming system of claim 1, further including:
a compressor connected to the intake line and compressing the reformed gas and the air to supply to the engine; and
a turbine connected to the exhaust line and rotating by the exhaust gas to generate power.

8. The fuel reforming system of claim 1, wherein the catalyst includes a lean NOx trap (LNT) which traps the nitrogen oxide included in the exhaust gas in a lean condition and desorbs the trapped nitrogen in a rich condition, and restores the nitrogen oxide included in the exhaust gas or the desorbed nitrogen oxide.

9. The fuel reforming system of claim 1, wherein the catalyst includes a selective catalytic reducer (SCR) restoring the nitrogen oxide included in the exhaust gas by use of a reducing agent.

10. The fuel reforming system of claim 1, wherein at the EGR line, an EGR valve adjusting a flow rate of the reformed gas, and an EGR cooler disposed at a rear end portion of the EGR valve and cooling the reformed gas are disposed.

11. The fuel reforming system of claim 10, wherein the reformer is disposed at a front portion of the EGR cooler in the EGR line.
